(19) United States
(12) Patent Application Publication
(10) Pub. No.: US 2012/0011726 A1
(43) Pub. Date: Jan. 19, 2012

(54) ROTARY CUTTER

(75) Inventor: MIKE LU, Taipei County (TW)

(73) Assignee: MIKE & TONY TRADING CO., LTD., Taipei County (TW)

(21) Appl. No.: 12/836,777

(22) Filed: Jul. 15, 2010

(51) Int. Cl. B26B 25/00

(52) U.S. Cl. 30/138

(57) ABSTRACT

A rotary cutter includes a rotatable cutter blade and a grinding element supported on a support at one side relative to the cutter blade for grinding the cutter blade. A gap is normally kept between the grinding element and the cutter blade. The support is operable to move the grinding element into friction contact with the rotating cutter blade when grinding is necessary during a cutting operation of the rotary cutter. The grinding element can be normally kept in friction contact with the cutter blade so that a grinding effect is produced when rotating the cutter blade during a cutting operation.

### BACKGROUND OF THE INVENTION

1. Field of the Invention

The present invention relates to a cutter for cutting fabrics or paper, and more particularly, to a rotary cutter which is equipped with a cutter blade grinding device for grinding the circular cutter blade during cutting.

2. Description of the Related Art

During a sewing and patching operation, a rotary cutter is commonly used with a cutting pad and a cutting rule to cut fabrics into strips and patches subject to the desired pattern. Further, a rotary cutter is also practical for use to cut paper.

FIG. 1 illustrates a conventional rotary cutter 30. The rotary cutter 30 comprises a handle 31 having a holder block 32 at its one end, a guard 35 slidably supported on the holder block 32, and a circular cutter blade 33 rotatably fastened to the holder block 32 by a pivot retainer 34. A sliding switch 36 is provided at the handle 31 and operable to move the guard 35 linearly relative to the circular cutter blade 33 through a transmission mechanism (not shown).

When the rotary cutter 30 is not used, press down the sliding switch 36 and then push the sliding switch 36 forwards to move the guard 35 to the bottom side of the circular cutter blade 33 to give protection, avoiding accidental injury by the circular cutter blade 33. On the contrary, when pressing down the sliding switch 36 and pushing the sliding switch 36 backwards to its former position, the guard 35 is moved away from the circular cutter blade 33, enabling the front side of the circular cutter blade 33 to be exposed to the outside for cutting. The circular cutter blade 33 is detachable for a replacement so that different circular cutter blades can be selectively used for a straight-edge cutting or serrated-edge cutting operation. The indicated circular cutter blade 33 is suitable for a straight-edge cutting operation.

Same as other cutting tools, the cutting edge of a circular cutter blade will become blunt after a long use, lowering the cutting efficiency. When this problem occurs, two measures may be selected, i.e., to replace the circular cutter blade, or to grind the cutting edge of the circular cutter blade. The subject to be discussed in the present invention is the grinding of a circular cutter blade. Because a conventional rotary cutter is not equipped with a cutter blade grinding device, a special cutter grinder must be used. However, a cutter grinder does not allow grinding of a rotary cutter directly. Before grinding, the user must detach the circular cutter blade from the rotary cutter. This grinding manner is inconvenient and wasting time. Further, an accidental finger injury may occur when detaching the circular cutter blade from the rotary cutter. Further, commercial cutter grinders are commonly expensive. To an ordinary individual user, it is not worth to prepare an expensive cutter grinder.

### SUMMARY OF THE INVENTION

The present invention has been accomplished under the circumstances in view.

It is one object of the present invention to provide a rotary cutter, which is equipped with a cutter blade grinding device for grinding the circular cutter blade during cutting, avoiding the inconvenience and danger in detaching the circular cutter blade.

It is another object of the present invention to provide a rotary cutter with an attached cutter blade grinding device, which saves the cost of purchasing a specific cutter grinder, thereby encouraging the consumers to buy and enhancing business success.

To achieve these and other objects of the present invention, a rotary cutter comprises a rotatable cutter blade, and a grinding element supported on a support at one side relative to the cutter blade and kept apart from the cutter blade by a gap. When pressing the support during operation of the rotary cutter, the grinding element is moved into friction contact with the cutter blade, producing a grinding effect.

In an alternate form of the present invention, the grinding element is normally kept in contact with the cutter blade so that a grinding effect is produced during rotation of the cutter blade.

In another alternate form of the present invention, the support is movable to adjust the gap between the grinding element and the cutter blade.

The advantage of the rotary cutter of the present invention is its attached cutter blade grinding device that allows grinding of the cutter blade during cutting, avoiding the inconvenience and danger in detaching the circular cutter blade, and adding an extra value to enhance competition and sales.

Other technical features, characteristics, benefits and advantages of the present invention will be fully understood by reference to the following specification in conjunction with the accompanying drawings.

### BRIEF DESCRIPTION OF THE DRAWINGS

FIG. 1 is a perspective view of a rotary cutter according to the prior art.

FIG. 2 is a sectional view of a part of a rotary cutter in accordance with a first embodiment of the present invention.

FIG. 3 is a sectional view of a part of a rotary cutter in accordance with a second embodiment of the present invention.

FIG. 4 is a sectional view of a part of a rotary cutter in accordance with a third embodiment of the present invention.

FIG. 5 corresponds to FIG. 4, showing the cutter blade grinding device isolated from the circular cutter blade by the guard.

FIG. 6 is a sectional view of a part of a rotary cutter in accordance with a fourth embodiment of the present invention.

FIG. 7 is a sectional view of a part of a rotary cutter in accordance with a fifth embodiment of the present invention.

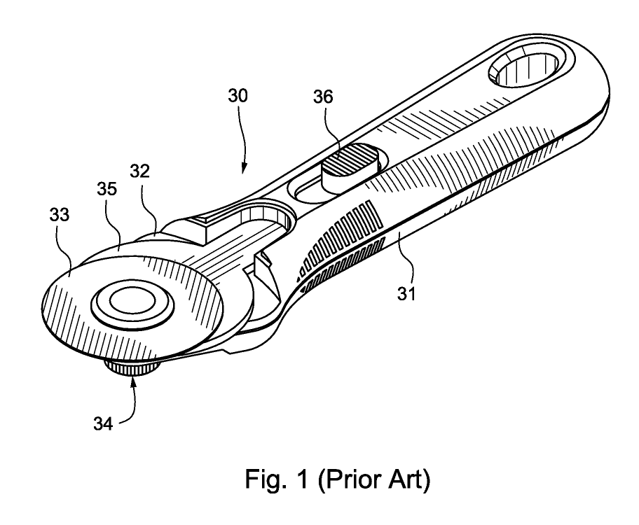

### DETAILED DESCRIPTION OF THE PREFERRED EMBODIMENT

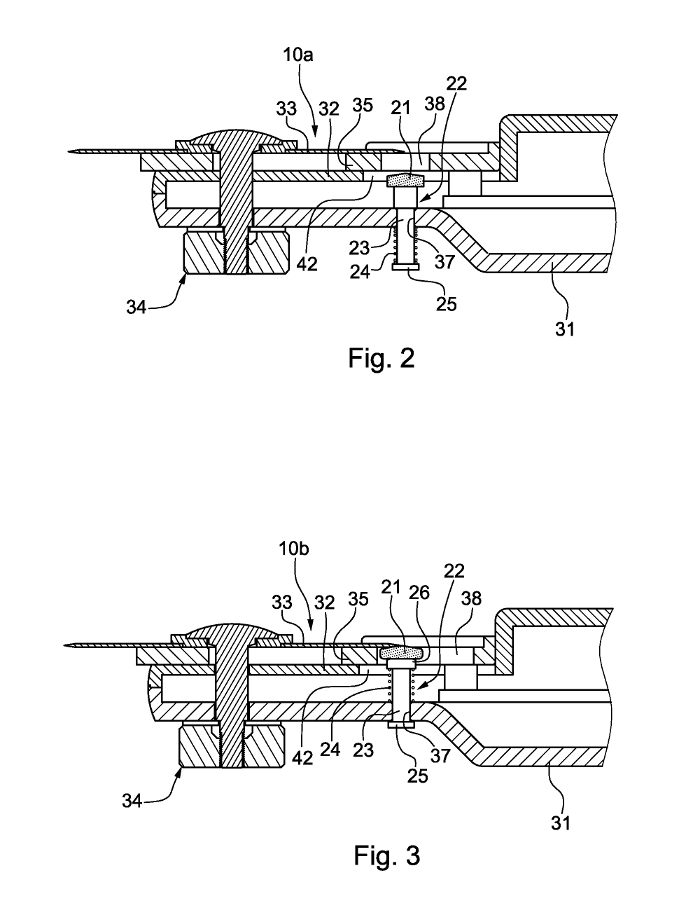

Referring to FIG. 2, a rotary cutter 10a in accordance with a first embodiment of the present invention is substantially similar to a conventional rotary cutter 30 with the exception of an extra cutter blade grinding device (no reference sign indicated). Because the base structure of the rotary cutter of the present invention is same as the aforesaid prior art design, like component reference signs are used to indicate like component parts.

The cutter blade grinding device comprises a support 22 and a grinding element 21. The support 22 comprises a rod member 23 and a compression spring 24. The rod member 23 is inserted through a mounting through hole 37 on the handle 31, having a radially expanded head 25 at its one end for easy manipulation with the fingers and also for supporting the compression spring 24. The other end of the rod member 23 is for the mounting of the grinding element 21. The compression spring 24 surrounds the periphery of the rod member 23, and is stopped between the handle 31 and the head 25 of the rod member 23 to impart a pressure to the rod member 23, keeping the grinding element 21 away from the circular cutter blade 33 by a gap.

The grinding element 21 is held by the support 22 at one side of the circular cutter blade 33 for grinding the cutting edge of the circular cutter blade 33. The grinding element 21 can be a grind stone or sand wheel. When a grind stone is used, it is affixed to the rod member 23. When a sand wheel is used, it is pivotally connected to the rod member 23. When using the rotary cutter 10a, press the rod member 23 to move the grinding element 21 through passages 42 and 38 in the holder block 32 and the guard 35 into contact with the circular cutter blade 33 for grinding. Because the grinding operation runs during cutting, the operation is convenient, time-saving and safe, avoiding the inconvenience and danger in detaching the circular cutter blade.

In the aforesaid first embodiment, a gap is normally kept between the grinding element 21 and the circular cutter blade 33. When grinding is necessary, press the rod member 23 to move the grinding element 21 into friction contact with the rotating circular cutter blade 33 to produce a grinding effect. A modification may be made to have the grinding element 21 be normally kept in contact with the circular cutter blade 33. FIG. 3 illustrates a rotary cutter 10b in accordance with a second embodiment of the present invention. This second embodiment is substantially similar to the aforesaid first embodiment with the exception of the installation location of the compression spring 24. According to this second embodiment, the compression spring 24 has its one end supported on the handle 31, and its other end supported on a flange 26 at the rod member 23. Thus, the grinding element 21 is normally kept in contact with the circular cutter blade 33. Under this condition, a grinding effect is produced when rotating the circular cutter blade 33. The head 25 and the flange 26 may be formed integral with or detachably fastened to the rod member 33 subject to the cutter blade grinding device mounting requirement.

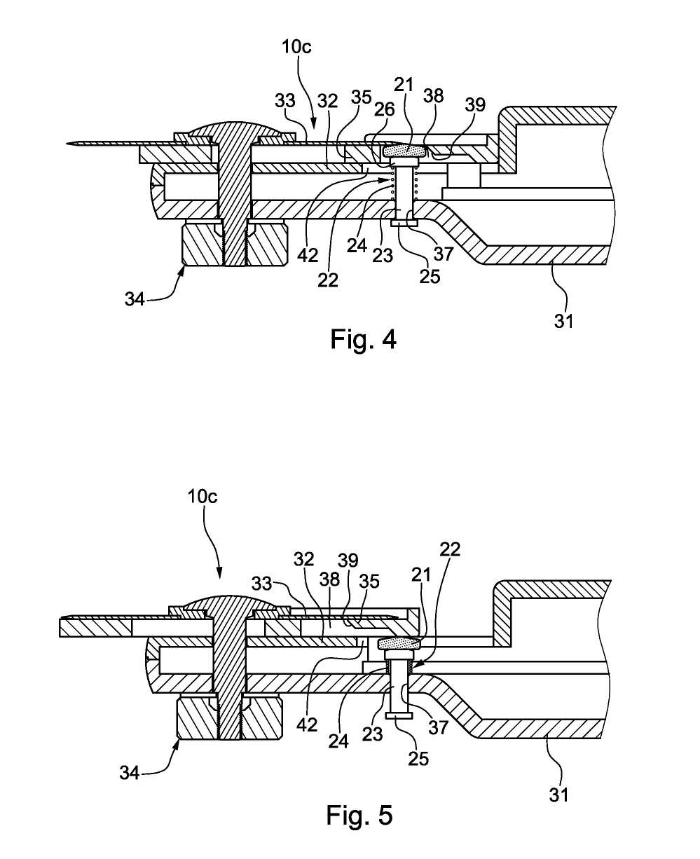

FIG. 4 illustrates a rotary cutter 10c in accordance with a third embodiment of the present invention. This third embodiment is substantially similar to the aforesaid second embodiment with the exception that the guard 35 has a beveled face 39 backwardly extended from the passage 38. When operating the sliding switch 36 to move the guard 35 into position for the purpose of safety, as shown in FIG. 5, the grinding element 21 is guided away from the circular cutter blade 33 by the beveled face 39, enabling the guard 35 to separate the grinding element 21 and the circular cutter blade 33. At this time, the compression spring 24 is compressed to preserve elastic energy for returning the grinding element 21 into contact with the circular cutter blade 33 when the sliding switch 36 is operated to reverse the guard 35 during a cutting operation.

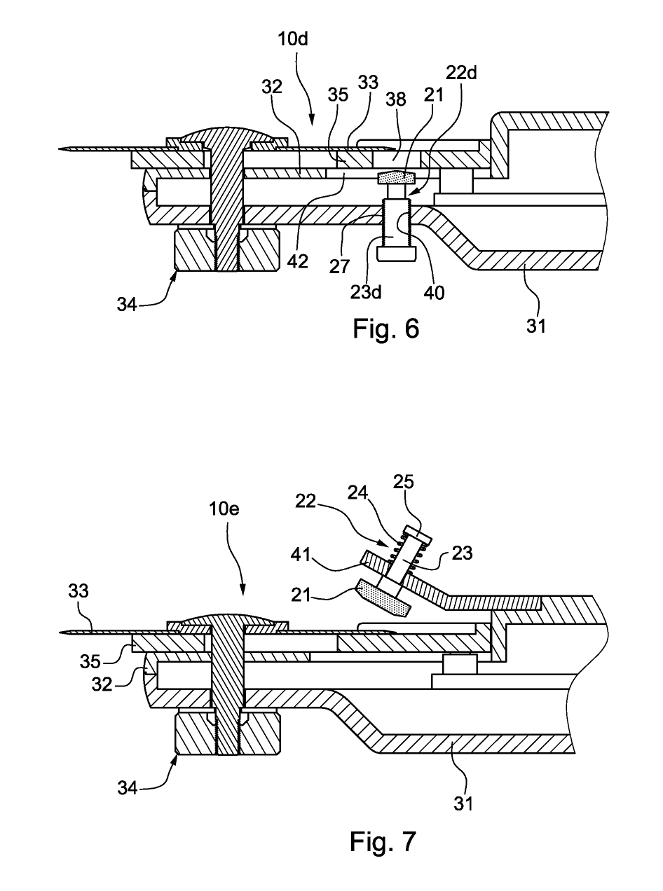

This invention is not limited to the aforesaid embodiments. FIG. 6 illustrates a rotary cutter 10d in accordance with a fourth embodiment of the present invention. According to this fourth embodiment, the support 22d of the cutter blade grinding device simply comprises a rod member 23d. The rod member 23d has a male thread 27 for threading into a screw hole 40 in the handle 31. Thus, the rod member 23d can be rotated forwards and backwards to adjust the gap between the grinding element 21 and the circular cutter blade 33, keeping the grinding element 21 into contact with or away from the circular cutter blade 33.

In the aforesaid first through fourth embodiments, the grinding element 21 is held by the support 22 (22d) at one side relative to the circular cutter blade 33. In a fifth embodiment of the present invention, as shown in FIG. 7, the grinding element 21 of the rotary cutter 10e is disposed at an opposite side relative to the circular cutter blade 33, achieving the same effect. According to this fifth embodiment, the handle 31 provides a bracket 41 for supporting the rod member 23 and the compression spring 24. The bracket 41 may be formed integral with or detachably fastened to the handle 31. Further, because the grinding element 21 and the guard 35 are disposed at two opposite sides relative to the circular cutter blade 33, the holder block 32 and the guard 35 do not require the passages 42 and 38.

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. A rotary cutter, comprising:
a handle having a holder block at a front side thereof;
a cutter blade rotatably supported on said holder block; and
a guard supported on said handle and movable relative to said cutter blade;
wherein a cutter blade grinding device is provided, comprising a support supported on said handle and a grinding element supported on said support and kept at one side relative to said cutter blade for grinding said cutter blade.

2. The rotary cutter as claimed in claim 1, wherein said support comprises a rod member supported on said handle, and a compression spring surrounding a part of the periphery of said rod member and stopped between said handle and said rod member and adapted to impart an elastic force for keeping said grinding element apart from said cutter blade by a gap.

3. The rotary cutter as claimed in claim 1, wherein said support comprises a rod member supported on said handle, and a compression spring surrounding a part of the periphery of said rod member and stopped between said handle and said rod member and adapted to impart an elastic force for keeping said grinding element in contact with said cutter blade.

4. The rotary cutter as claimed in claim 1, wherein said support comprises a rod member threaded into a part of said handle and rotatable relative to said handle to move said grinding element relative to said cutter blade.

5. The rotary cutter as claimed in claim 1, wherein when said grinding element and said guard are disposed at one same side relative to said cutter blade; said holder block and said guard each have a passage for the passing of said grinding element during movement of said support relative to said handle.

6. The rotary cutter as claimed in claim 5, wherein said guard comprises a beveled face extended from the passage thereof for guiding said grinding element away from said cutter blade during movement of said guard toward said cutter blade.
